(19) United States
(12) Patent Application Publication
(10) Pub. No.: US 2010/0082533 A1
(43) Pub. Date: Apr. 1, 2010

(54) UPDATE METHOD FOR DATABASE

(76) Inventors: Takashi Nakamura, Tokyo (JP); Mayumi Taniguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/597,389

(22) PCT Filed: Aug. 9, 2007
(86) PCT No.: PCT/JP2007/065624

§ 371 Date: Oct. 23, 2009

(30) Foreign Application Priority Data
Apr. 27, 2007 (JP) 2007-120045

(51) Int. Cl. G06F 17/30

(52) U.S. Cl. 707/609; 707/769; 707/E17.014; 707/E17.005

(57) ABSTRACT

A user can register and update information in the database even through a terminal having no authority to access the database server. A method of updating a database for using an e-mail received by a mail server to update information stored in a storage means of a database server is prepared. A central processing unit of the database server verifies an account and a data ID shown in a subject space of an e-mail read from a receipt mail box of a mail server with a security master storing therein an IP address and a mail address associated with the account of the user. When the account and the data ID correspond are verified, it is determined that the information corresponding to the data ID stored in the storage means is to be updated.

### TECHNICAL FIELD

The present invention relates to a method of updating a database. In particular, the present invention relates to a method of updating a database by which an e-mail is used to update information stored in the database.

### BACKGROUND ART

Conventionally, the access to a database server connected to the Internet or the Intranet is restricted for the purpose of maintaining the security of the information stored therein. In order to allow a user to update the contents of the database or to upload a file, the user must input, for example, a user ID and a password through a log-in screen provided from the server so that the user can be authenticated.

The following section will consider a case where an employee of a certain company tries to access a database server of the company connected to the Intranet. When the employee access to the database server through a terminal connected to the Intranet, the employee himself or herself accesses the database server through a login screen as described above. When an employee working at home for example accesses the database server, the employee must use a terminal at his or her home to access the database server via the Internet and the firewall. This access also requires authentication to identify the employee himself or herself.

On the other hand, from the viewpoint of enhancing the security, the access to a terminal capable of having an access to the database server also may be restricted regarding the upload of a specific file. Furthermore, a terminal of an agency of the company or a terminal of a business partner company for example also may be restricted for the access so that the terminal can access only to a specific server. Furthermore, a mobile terminal having no application for performing interaction with a server (e.g., mobile phone, PDA) cannot access the database server. Since a required file cannot be uploaded from such a terminal to the server, an e-mail or the like is used to once transmit the file from a mail server of the company to the terminal of the company and then the file is uploaded by an employee of the company to the database server.

As an example, a database server of a business system of a casualty insurance company will be considered. The business system includes a customer database for customer management, a contract database for controlling insurance contracts, and an accident database for controlling accident information for example. Among them, the accident database stores therein, when an accident covered by the payment of insurance money occurs, the detailed accident information for each accident. Among the accident information, information regarding the accident site (e.g., photograph of actual articles, an interview report at the site) is important. Prompt collection of accurate information is also required.

However, when information collected by employee of the casualty insurance company at the site is transmitted from a mobile phone or a PDA, since the mobile phone or PDA cannot directly access the accident database as described above, the information must be once transmitted to a mail server of the company. Information collected by an employee of the agency or the like also must be once transmitted to the mail server of the company. This has caused an advantage that an operation for transferring the information from the mail server to the accident database increases the man-hours required for the accident processing and also deteriorates the promptness.

It is an objective of the present invention to provide a method of updating a database by which the transfer of data from the mail server to the database is simplified and a user can register and update information in the database even through a terminal having no authority to access the database server.

### DISCLOSURE OF THE INVENTION

In order to achieve the objective as described above, the present invention is a method of updating a database for using an e-mail received by a mail server to update information stored in a storage means of a database server, characterized by including: a first step of allowing a central processing unit of the database server to search a receipt mail box of the mail server to readout an electronic mail addressed to the database server; a second step of allowing the central processing unit to extract an account and a data ID shown in a subject space of the e-mail to extract an IP address and a mail address of a source of the e-mail; a third step of allowing the central processing unit to refer a security master storing an IP address and a mail address associated with an account of a user to read out an IP address and a mail address corresponding to the account shown in the subject space; and a fourth step of allowing, when the IP address and the mail address of the source of the electronic mail are identical with the IP address and the mail address read by the security master, respectively, the central processing unit to determine that the information stored in the storage means corresponding to the data ID shown in the subject space is to be updated.

According to this method, the central processing unit of the database server performs the security check of the e-mail. Thus, the data transfer from the mail server to the database can be simplified and whether the registration and update in the database is possible or not can be determined even through a terminal having no authority to access the database.

Furthermore, the method also can include a fifth step of attaching a spread sheet in which attributes and digits or the like of items are defined in advance based on predetermined rules as an update file to the e-mail and allowing the central processing unit to read out the update file from the receipt mail box of the mail server; and a sixth step of allowing, when the fourth step determines that the information is to be updated, the central processing unit to update, regarding an item shown in the update file, the corresponding item of the information associated with the data ID stored in the storage means.

According to this method, an e-mail can be used to update the information stored in the database without having a direct access to the database from the terminal.

Furthermore, the method also can include a seventh step of allowing the central processing unit to read out an attached file attached to the e-mail from the receipt mail box of the mail server; and a eighth step of allowing the central processing unit to associate the account with the data ID to store the attached file in the storage means.

### BRIEF DESCRIPTION OF THE DRAWINGS

FIG. 1 is a configuration diagram illustrating a business system according to one embodiment of the present invention;

FIG. 2 is a block diagram illustrating a database server according to one embodiment of the present invention;

FIG. 3 illustrates an example for registration and update in a database;

FIG. 4 illustrates an example of a format of an update file;

FIG. 5 illustrates an example of a format of an update pattern;

FIG. 6 illustrates a screen displaying a list of accident data files stored in the accident information database;

FIG. 7 illustrates a screen displaying an example of an accident data file;

FIG. 8 illustrates a screen displaying an example of an attached file stored in the accident data file;

FIG. 9 illustrates a screen displaying an example of a photograph file stored in the accident data file;

FIG. 10 illustrates a screen displaying an example of a document file stored in the accident data file;

FIG. 11 is a diagram showing the relationship of FIGS. 11A and 11B;

FIG. 11A illustrates a screen displaying a list of update information stored in an update history database; and

FIG. 11B illustrates a screen displaying a list of update information stored in the update history database.

### BEST MODE FOR CARRYING OUT THE INVENTION

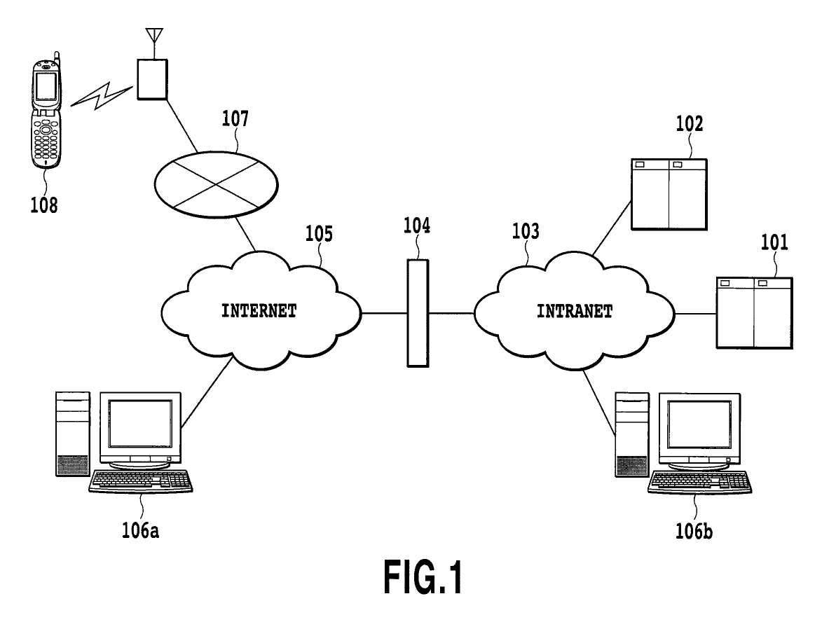

The following section will describe an embodiment of the present invention with reference to the drawings. FIG. 1 shows a business system according to one embodiment of the present invention. The business system includes a database server 101 connected to the Intranet 103 and a mail server 102. The Intranet 103 is connected to the Internet 105 via a fire wall 104. A user can access the database server 101 through terminals 106a and 106b connected to the Intranet 103 or the Internet 105. The user can transmit an e-mail and an electronic file via a mobile communication network 107 from a mobile terminal 108 to the mail server 102.

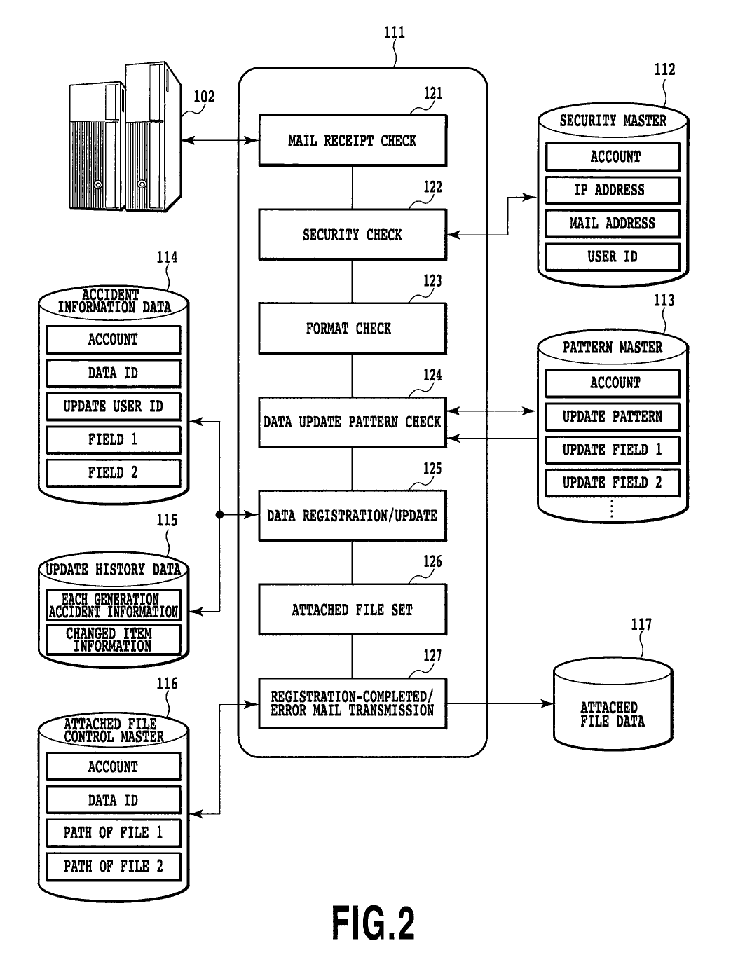

FIG. 2 shows a database server according to one embodiment of the present invention. The database server 101 includes: a central processing unit 111 and, as a storage means connected to the central processing unit 111, a security master 112, a pattern master 113, an accident information database 114, an update history database 115, an attached file control master 116, and an attached file database 117. Data stored in the storage means of the database server 101 is controlled based on an account of each customer and accident data ID for every accident. When an accident occurs, accident information file associated with an account and an accident data ID is prepared in the accident information database 114. In this embodiment, the accident information file also may be considered as a folder for every one accident and can include accident data files in which the contents of the accident are described by predetermined items and other files.

A user of a casualty insurance company or agency can transmit an e-mail from the terminals 106a and 106b or the mobile terminal 108 to the mail server 102 to register accident information in an accident data file or to register an attached file. The user also can transmit an e-mail to the mail server 102 to update the accident information registered in the accident data file. The following section will describe the function performed by the central processing unit 111 in order to register and update the accident information and the contents of the information stored in the storage means.

The following section will describe a method of registering and updating, through the terminal of the agency 106a, photographs of actual articles collected at the accident site and detailed accident information together with a copy of an insurance money invoice in the database server 101 of the casualty insurance company.

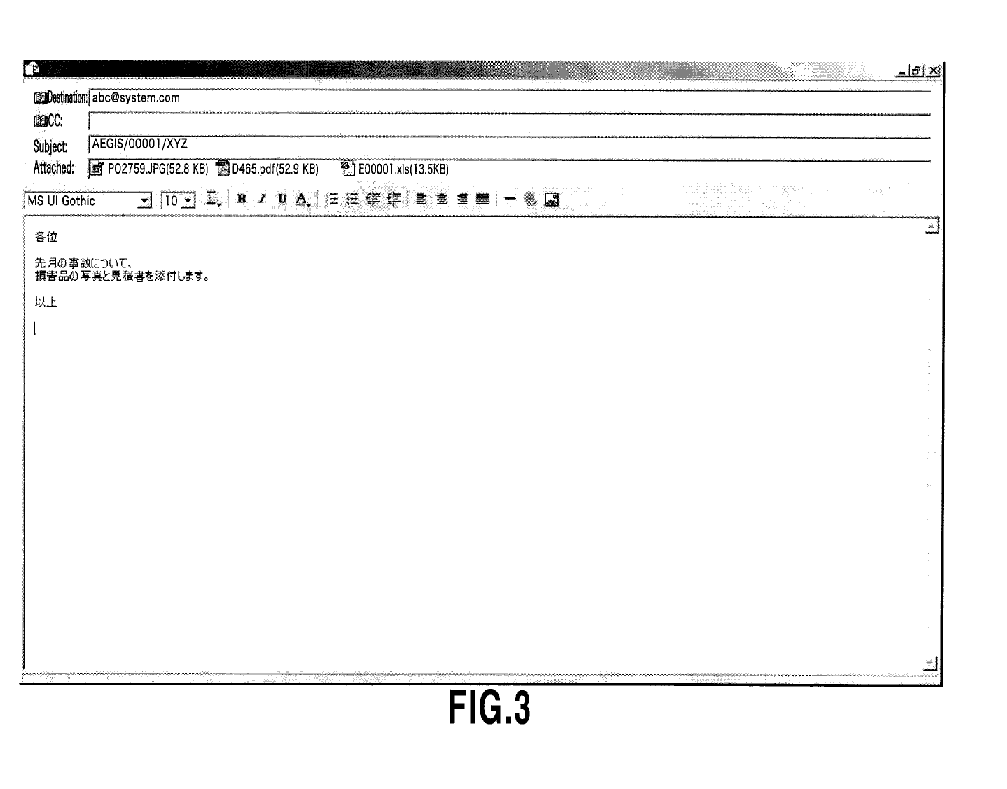

FIG. 3 shows an example of an e-mail to register and update information in the database. First, the user of the terminal 106a uses an e-mail application to prepare an e-mail to be transmitted to the mail server 102 of the casualty insurance company. The e-mail must be prepared based on rules (format) determined in advance. The “subject” is described in an order of the server ID of the database server 101, the accident data ID and the account. In this case, the server ID is “AEGIS”, the accident data ID is “00001”, and the account is “XYZ”. The “destination” is abc@system.com showing the address of the database server 101 registered in the mail server 102. The contents of the body text can be written freely.

An attached file for updating an accident data file based on the photograph of actual articles and collected accident information (hereinafter referred to as update file) for example is also has a file name determined based on rules (format) determined in advance. In this case, the photograph file name is “P+serial number (02759)”, the update file name is “E+accident data ID (00001)”, and other document filenames are “D+serial number (465)”. In this way, the capital letter of the file name can show an attribute of an attached file. In FIG. 3, three files are attached.

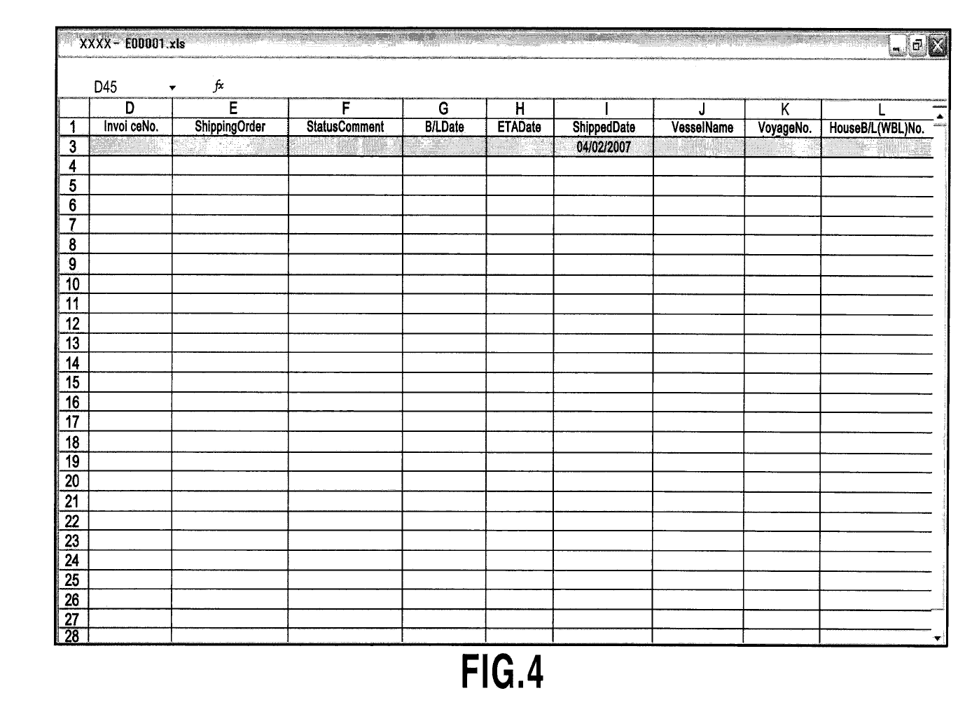

FIG. 4 shows an example of the update file. The update file is a spread sheet in which attributes, digits or the like of items are defined based on rules (format) determined in advance. For example, each column corresponds to an accident information item and a user inputs numeric values or text characters or the like to the applicable items. For example, the accident data file item corresponds to the accident information item of each column in the spread sheet to have one-to-one relation.

The e-mail thus prepared is transmitted from the terminal 106a to the mail server 102 and is stored in a receipt mail box of the mail server 102. On the other hand, the database server 101 carries out a mail receipt check function 121 (FIG. 2). The database server also searches, at a fixed time interval, the receipt mail box of the mail server 102 to read out a newly-arrived e-mail (i.e., newly-arrived mail addressed to abc@system.com) to store the mail in the central processing unit 111.

The database server 101 carries out the security check function 122 (FIG. 2) to check whether or not the newly-arrived e-mail is transmitted from a user permitted to perform the registration and update in the database. The security master 112 shown in FIG. 2 stores therein, in a manner associated with an account of each customer, the IP address and the mail address of the terminal 106a of customer as well as the user ID identifying the user of the terminal 106a. The central processing unit 111 extracts the account from the “subject” of the e-mail picked up from the mail server 102 and extracts the IP address and the mail address of the source. The central processing unit 111 refers, based on the extracted account, to the IP address and the mail address stored in the security master 112 to compare the extracted IP address and the mail address with the stored IP address and mail address, respectively. It is noted that both of the IP address and the mail address may be checked or any of the IP address and the mail address also may be checked.

When the extracted IP address and the mail address are not identical with the stored IP address and the mail address, a security mail showing that an electronic mail from a user not permitted to perform registration and update in the database is received is transmitted to a terminal of a person in charge of control connected to the Intranet 103.

When the extracted IP address and the mail address are identical with the stored IP address and the mail address, whether the format of the “subject” is based on the above-described predetermined rules or not is confirmed. Whether the corresponding user ID of the security master 112 corresponds to a user permitted to perform registration and update in the database or not is judged. When the format of the “subject” is not based on the predetermined rules or when the corresponding user ID of the security master 112 does not correspond to a user permitted to perform registration and update in the database, a security mail is transmitted to the terminal of the person in charge of control.

When the format of the “subject” is based on the predetermined rules, the electronic mail is from a user permitted to perform registration and update in the database. Then, the processing proceeds to a format check 123 of an update file (FIG. 2). Based on predetermined rules, an attached file having a file name having an initial letter of E can be determined as an update file. Thus, the central processing unit 111 picks up the update file from the receipt mail box of the mail server 102. The central processing unit 111 confirms whether or not the attributes and digits or the like of the items of the picked up update file item are based on the above-described predetermined rules.

Specifically, as described above, whether an item of each column of the update file corresponds to an item of the accident data file based on one-to-one relation or not is confirmed. Next, with regard to each item, an attribute of an input item is confirmed by confirming, for example, whether or not an input value of a numeric value item is a numeric value, whether or not the input value is an input value having specified digits or less, whether or not an input value of a date item shows a date, and whether or not an input value of a character item is a text character. When the format check as described above shows that the attribute, digits or the like does not correspond to the corresponding attribute, digits or the like, a security mail is transmitted to the terminal of a person in charge of control. When an input value exists in column other than the predetermined column, the update file may be ignored or a security mail also may be transmitted to show that the file does not have the corresponding attribute.

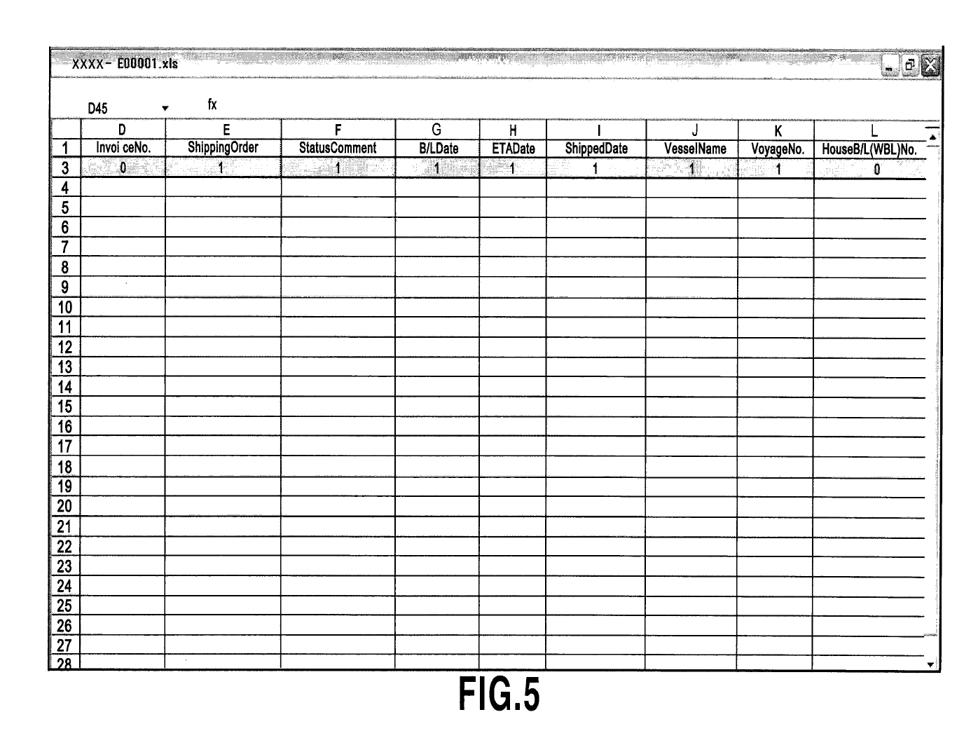

When the attribute, digits or the like corresponds to the corresponding attribute, the update file is subjected to a data update pattern check 124 (FIG. 2). The pattern master 113 shown in FIG. 2 includes a registered update file update pattern associated with an account of each customer. FIG. 5 shows an example of an update pattern. The update pattern shows, with regard to the respective items in the update file, whether or not the items are to be updated (i.e., whether or not the items require the accident information of the accident data file registered in the accident information database 114 to be updated). The update pattern is also a spread sheet in which accident information items in each column correspond to the update file based on a one-to-one relation and includes flags defined to show whether or not the items is to be updated. In FIG. 5, an update flag is 1 and a no-update flag is 0. The central processing unit 111 compares the items of the update file picked up from the mail server 102 with the update pattern read out from the pattern master 113 to determine items in the accident information of the accident data file that are to be updated.

Even when all items of the picked up update file have data, when the update pattern of the pattern master 113 includes only a specific item having a flag showing that the item is to be updated, only the item having the flag is determined as the one to be updated and the other items are not determined as the one to be updated.

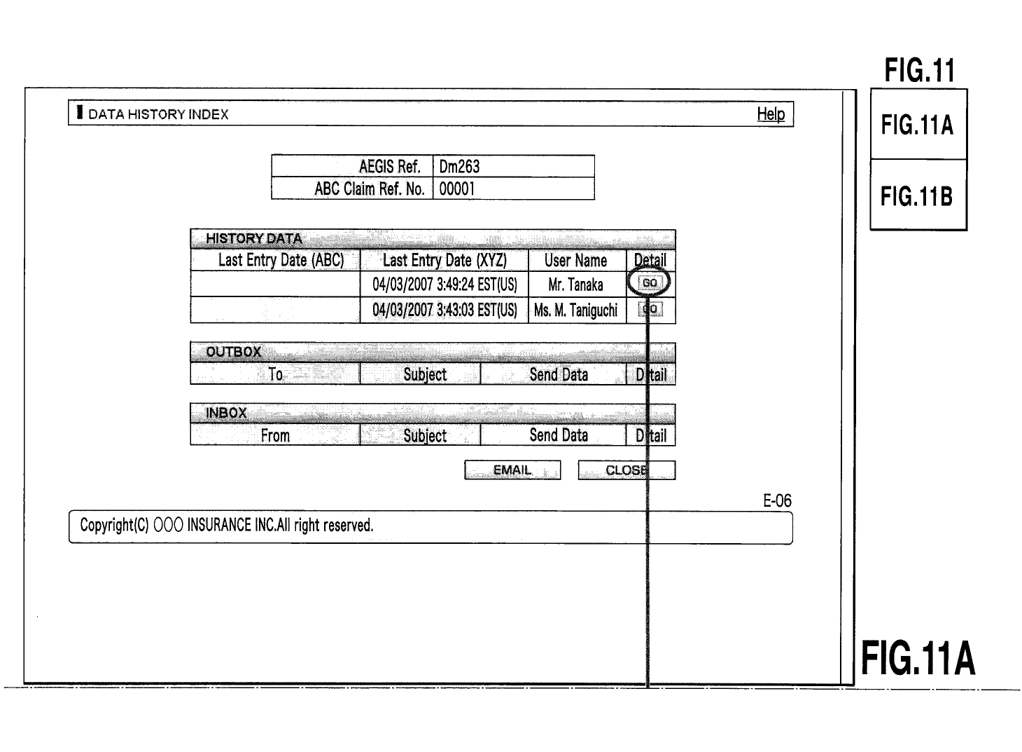

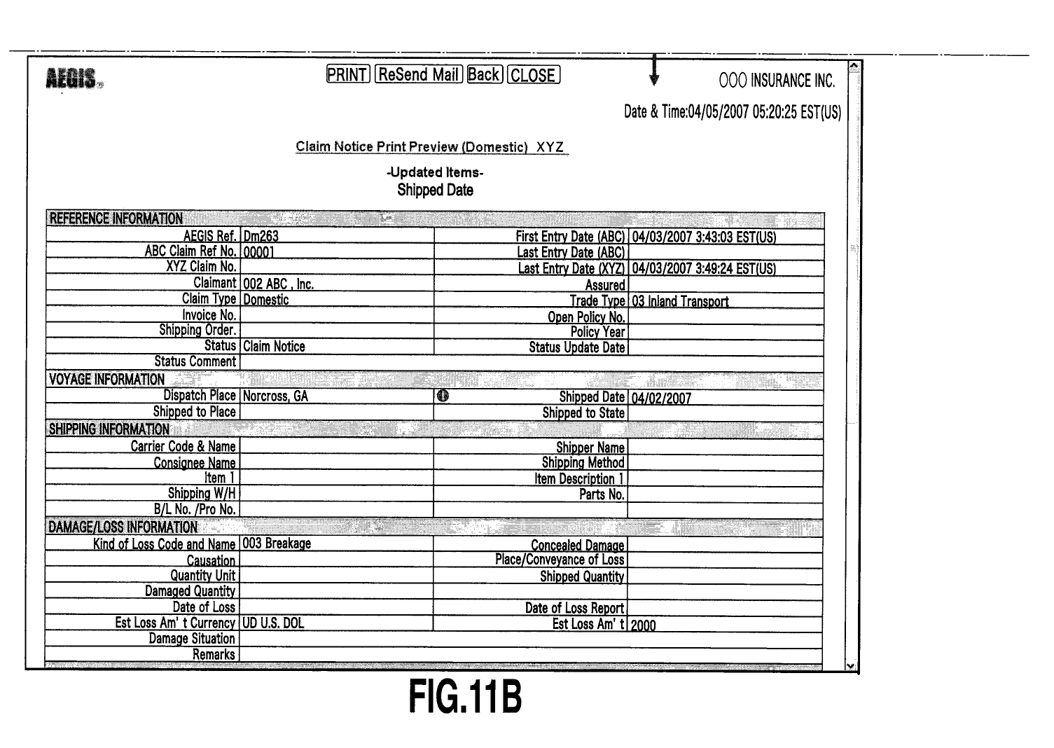

The central processing unit 111 extracts the accident data ID from the “subject” of the e-mail picked up from the mail server 102 and identifies the accident information file stored in the accident information database 114 and the update history file stored in the update history database 115. When the accident data file exists in the accident information file, then an item defined in the update pattern among the items of the update file is subjected to a registration/update processing 125 based on the input value of the update file (FIG. 2). When no accident data file exists in the accident information file, a new accident data file is registered based on the input value of the update file. In this registration, the user ID identified by the security check function 122 is registered as an update user ID. The update method will be described later with reference to FIG. 11.

Next, the central processing unit 111 subjects a file other than the update file to the attached file registration 126 (FIG. 2). Based on the predetermined rules, an applicable file can be determined based on the initial letter of the attached file. Thus, the central processing unit 111 picks up the attached file from the receipt mail box of the mail server 102. The attached file control master 116 shown in FIG. 2 stores therein a path name showing where the attached file is stored so that the path name is associated with the account of every customer and the accident data ID of every accident. Te central processing unit 111 stores the attached file picked up from the mail server 102 in the attached file database 117 and registers the place where the attached file database 117 is stored in the attached file control master 116.

When the registration and update of the accident data file and the storage of the attached file are completed, then a registration-completed mail is transmitted to both of the user of the terminal 106a from which the e-mail was sent and the person in charge of control. When an error occurs during the registration and update, a security mail is transmitted to the sender of the e-mail and the person in charge of control.

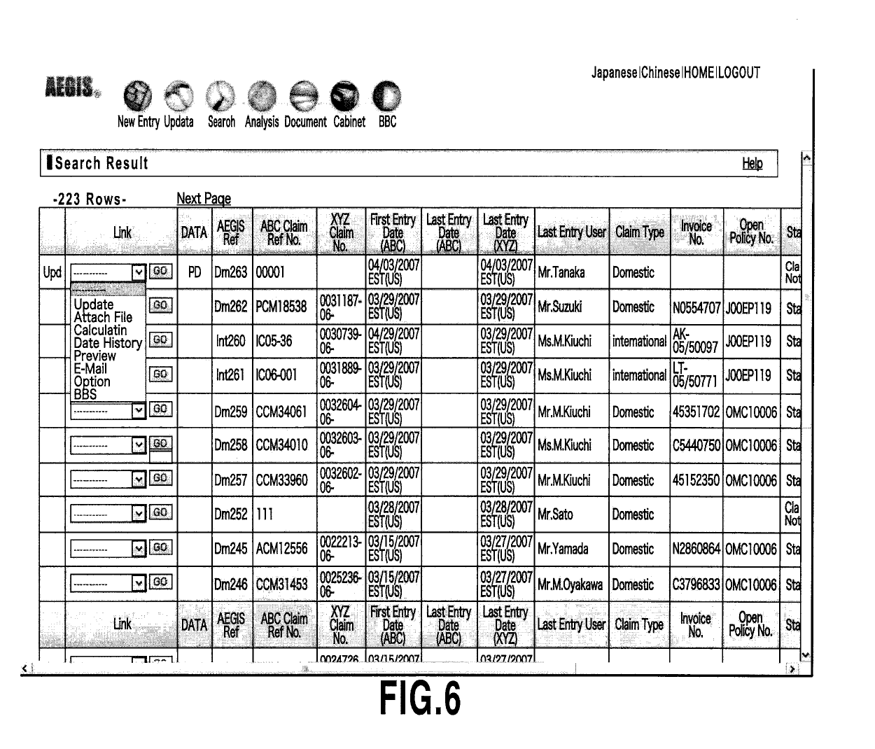

FIG. 6 shows a screen displaying an example of the accident data file stored in the accident information database. The accident data file of each accident is displayed in one row. In the above description, the accident information having the accident data ID of “00001” was updated. Thus, a mark showing that the item is updated (“Upd”) is displayed in the first column of the applicable case (case for which “00001” is shown in the first row of “CUSA Claim Ref. NO”). In the screen of FIG. 6, an accident information item is displayed in each column.

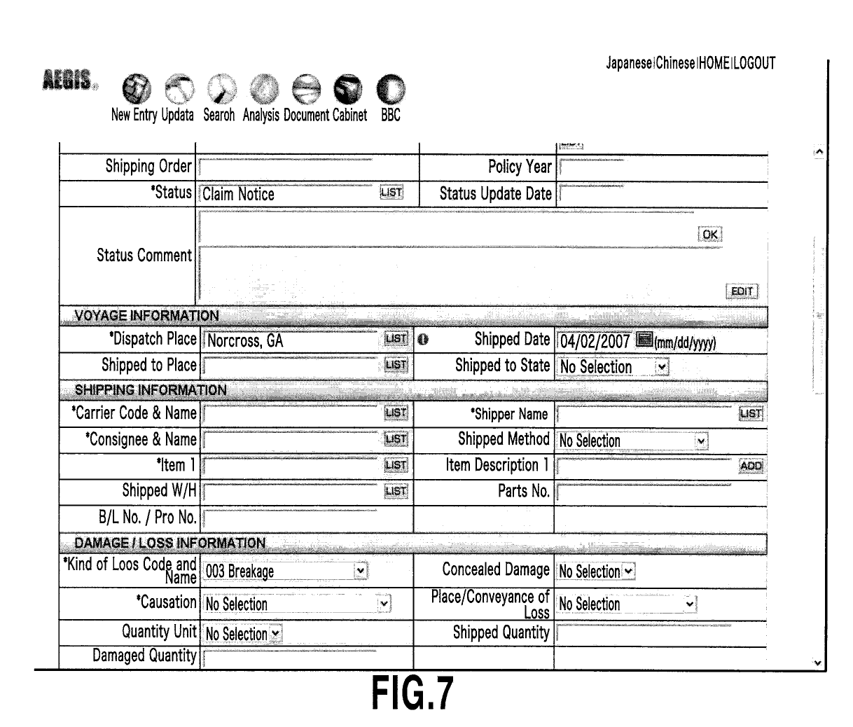

FIG. 7 illustrates a screen displaying an example of the accident data file. This screen displays the accident data file corresponding to one accident. This screen is a screen displayed when “Update” is selected through the pull-don menu in the “Link” space of the screen shown in FIG. 6. In the update file shown in FIG. 4, the item “ShippedDate” has an input value of “04/02/2007”. Thus, the applicable item of the accident data file is updated and a mark showing that the item is updated (“!”) is displayed.

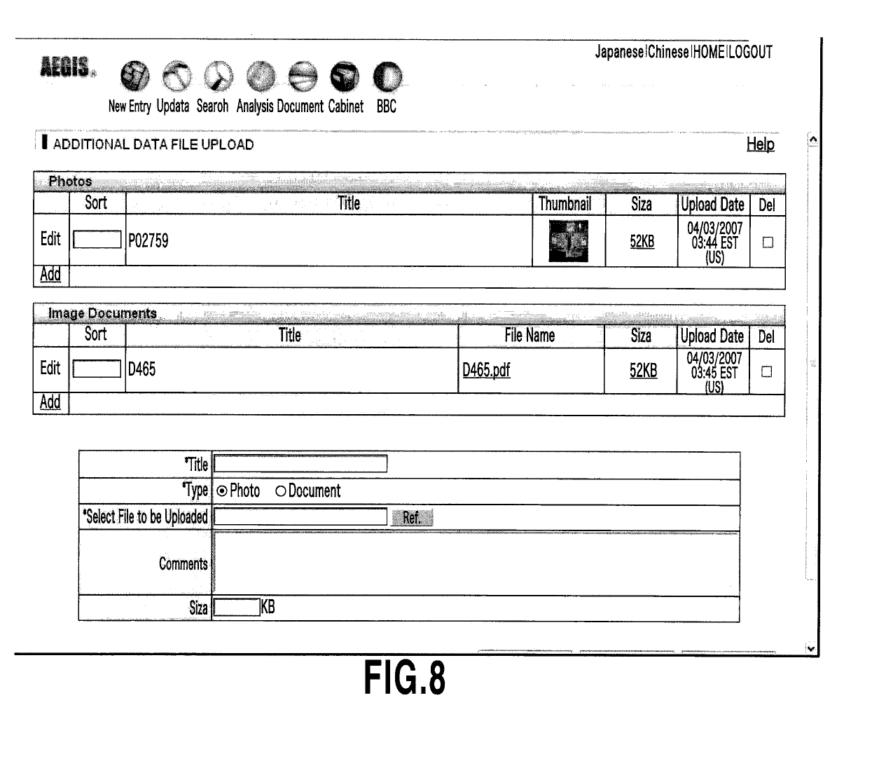

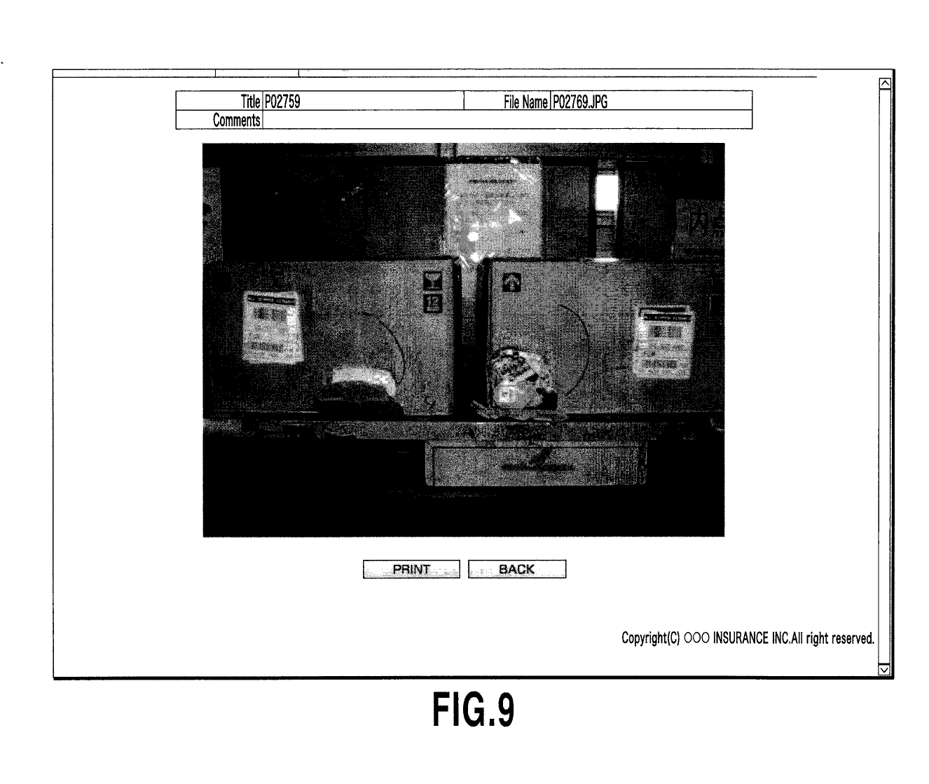

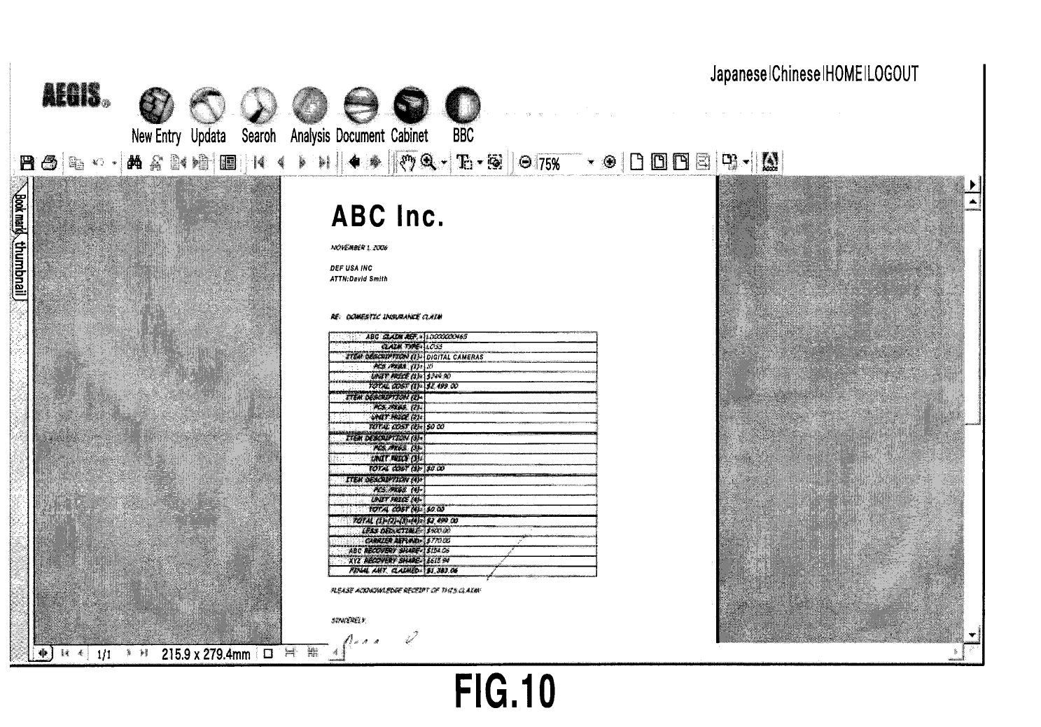

FIG. 8 illustrates a screen displaying an example of an attached file stored in the accident data file. This screen is a screen displayed when “Attached File” is selected through the pull-don menu in the “Link” space of the screen shown in FIG. 6. In the above description, a photograph file (P02759) and a document file (D465) are displayed as an attached file. When a photograph thumbnail is selected, the attached file control master 116 is referred and, as shown in FIG. 9, the photograph of the actual article stored in the attached file database 117 is displayed. When the document file is selected, the attached file control master 116 is referred and, as shown in FIG. 10, a copy of the insurance money invoice stored in the attached file database 117 is displayed.

The following section will describe the registration/update processing 125 shown in FIG. 2 in detail. The accident information database 114 and the update history database 115 are stored in a part of the accident data file depending on the update history, respectively. The accident information database 114 always stores the latest accident information (i.e., the latest input values in the respective items). The update history database 115 on the other hand stores the accident information of each generation whenever the update processing is carried out. If the update history database 115 stores the accident information regarding all items of the updated generations, the storage capacity is increased. Thus, the update history database 115 stores only updated items of the respective generations. The update history database 115 includes an each generation accident information file storing therein updated items of the respective generations and a changed item information file showing updated items of each generation.

Specifically, items of the first generation accident data file are considered that the items are all updated and thus all of the items are stored in the each generation accident information file. Regarding the second generation accident data file, only an updated item is stored in the each generation accident information file.

FIGS. 11A and 11B illustrate a screen displaying a list of update information stored in the update history database. FIG. 11A shows a screen displayed when “Data History” is selected through the pull-don menu in the “Link” space of the screen shown in FIG. 6. The screen shows that the accident data file is updated in the two generations. The central processing unit 111 firstly displays the first generation accident data file and then updates the displays of the updated items based on the second generation accident data file to display a mark showing that the item is updated. The screen in this case displays the above-described registration and update processing shown in the first row. When “Detail” is selected, as shown in FIG. 11B, a detail screen is displayed. In the update file shown in FIG. 4, the item “ShippedDate” has an input value of “04/02/2007”. Thus, a mark showing that the item is updated (“!”) is displayed in the applicable item.

According to this embodiment, data transfer from a mail server to a database can be simplified and a user can register and update information in the database even through a terminal having no authority to access a database server. Furthermore, an e-mail can be used to update information stored in the database without having a direct access from the terminal to the database.

1. A method of updating a database for using an e-mail received by a mail server to update information stored in a storage means of a database server, comprising:
a first step of allowing a central processing unit of the database server to search a receipt mail box of the mail server to read out an electronic mail addressed to the database server;
a second step of allowing the central processing unit to extract an account and a data ID shown in a subject space of the e-mail to extract an IP address and a mail address of a source of the e-mail;
a third step of allowing the central processing unit to refer a security master storing an IP address and a mail address associated with an account of a user to read out an IP address and a mail address corresponding to the account shown in the subject space; and
a fourth step of allowing, when the IP address and the mail address of the source of the electronic mail are identical with the IP address and the mail address read by the security master, respectively, the central processing unit to determine that the information stored in the storage means corresponding to the data ID shown in the subject space is to be updated.

2. The method of updating a database according to claim 1, further comprising:
a fifth step of attaching a spread sheet in which attributes and digits or the like of items are defined in advance based on predetermined rules as an update file to the e-mail and allowing the central processing unit to read out the update file from the receipt mail box of the mail server; and
a sixth step of allowing, when that the information is to be updated is determined at the fourth step, the central processing unit to update, regarding an item shown in the update file, the corresponding item of the information associated with the data ID stored in the storage means.

3. The method of updating a database according to claim 2, wherein the sixth step includes:
a step of allowing the central processing unit to refer a pattern master that is associated with the account of the user and that stores therein an update pattern in which a item to be updated is defined among the information stored in the storage means; and
a step of updating the information associated with the data ID with regard to only the item to be updated defined in the update pattern among the items defined in the update file.

4. The method of updating a database according to claim 1, further comprising:
a seventh step of allowing the central processing unit to read out an attached file attached to the e-mail from the receipt mail box of the mail server; and
a eighth step of allowing the central processing unit to associate the account with the data ID to store the attached file in the storage means.

5. The method of updating a database according to claim 4, wherein, at the eighth step, the central processing unit determines an attribute of the attached file based on a capital letter of a file name of the attached file.
